(19) United States
(12) Patent Application Publication
(10) Pub. No.: US 2008/0049563 A1
(43) Pub. Date: Feb. 28, 2008

(54) Optical element and optical head

(75) Inventors: Kenji Konno, Sakai-shi (JP); Koujirou Sekine, Ibaraki-shi (JP)

Correspondence Address: SIDLEY AUSTIN LLP, 717 NORTH HARWOOD, SUITE 3400, DALLAS, TX, 75201, US

(73) Assignee: KONICA MINOLTA OPTO, INC.

(21) Appl. No.: 11/891,859

(22) Filed: Aug. 14, 2007

(30) Foreign Application Priority Data
Aug. 23, 2006 (JP) 2006-226327
Jun. 19, 2007 (JP) 2007-161239

(51) Int. Cl. G11B 11/00

(52) U.S. Cl. 369/13.24

(57) ABSTRACT

An optical element for being carried on a slider moving over a recording medium, the optical element being made of a fluid material that transmits light guided from a light source, the optical element which includes a groove an first end which is open and an second end is closed, and a deflection surface for deflecting a light coming from the aforementioned second end of the groove, wherein the thickness of the aforementioned fluid material forming the bottom of the groove is greater on the second end than on the first end.

This application is based on Japanese Patent Application No. 2006-226327 filed on Aug. 23, 2006, and No. 2007-161239 filed on Jun. 19, 2007, in Japanese Patent Office, the entire content of which is hereby incorporated by reference.

### TECHNICAL FIELD

The present invention relates to an optical element and an optical head.

### BACKGROUND

According to the magnetic recording method, an increase of recording density causes the magnetic bit to be more seriously affected by external temperature. This requires the recording medium having a higher coercive force. However, use of such a recording medium need a stronger magnetic field for recording. The upper limit of the magnetic field produced by the recording head is determined by the saturated magnetic flux density, but the value is close to the limit of the material; thus, a drastic increase cannot be expected. One of the proposals to solve this problem is a method wherein a magnetic softening is caused by local heating at the time of recording, and recording is started when the coercive force has been reduced, Then heating is stopped so that natural cooling is performed, whereby the stability of the recorded magnetic bit is ensured. This method is also called a heat-assisted magnetic recording method.

In the heat-assisted magnetic recording method, a desirable step is instantaneous heating of the recording medium. Further, the heating mechanism is not allowed to come into contact with the recording medium. Thus, use of light absorption is commonly practiced for heating. The method of using light for heating is called an optically assisted method.

When the optically assisted method is used for extra-high density recording, the required spot diameter is about 20 nm. In a normal optical system, there is a limit to diffraction, which prevents light from being concentrated to that extent.

This problem can be solved by using a near field optical head wherein the light of near field emitted from the optical aperture having a size equal to or less than incident light wavelength.

For an example of the near field optical head, there is a near field optical head made up of a mirror substrate, aperture substrate and optical fiber. The mirror substrate has a mirror surface created by evaporation of aluminum on a slope formed by anisotropic etching on a Si substrate. On the mirror substrate, a V-groove is formed by etching, and an optical fiber is fixed and bonded therewith. The aperture substrate is made of SiO₂, and a micro lens having a diameter of 0.2 mm is formed on the upper surface. A slider for air cushion and an approximately rectangular parallelepiped near field light emitting minute structure are formed on the bottom surface of the aperture substrate. The light emitted from the optical fiber is reflected by the mirror surface, is converged by a micro lens, and is applied to the near field light emitting minute structure (Unexamined Japanese Patent Application Publication No. 2003-6913).

An example wherein an optical waveguide and an optical fiber are optically and mechanically connected instead of the micro lens in the aforementioned example is found in an optical fiber alignment component made up of:

a V-shaped groove for positioning the optical fiber to be optically connected with the optical waveguide, this V-groove member containing a transparent thermosetting plastics or thermoplastic and being formed by transferring the V-shaped groove created in the die;

an optical fiber bonded and fixed with the transferred V-shaped groove;

a transparent plate-formed member bonded and fixed thereon; and

a butt end for connection with the optical waveguide substrate having the aforementioned optical waveguide (Unexamined Japanese Patent Application Publication No. H9-152522).

However, according to the Unexamined Japanese Patent Application Publication No. 2003-6913, in the mirror substrate, a slope is formed by anisotropic etching on the Si substrate and a mirror surface is formed by aluminum evaporation. Further, the V-groove for fixing and bonding the optical fiber is also formed by etching. Thus, the V-groove fixed and bonded to the optical fiber, and the mirror surface for deflecting light from the optical fiber are formed as an integral component. However, the steps for forming this structure are very complicated.

In the Unexamined Japanese Patent Application Publication No. H9-152522, as an optical fiber alignment component for collective connection of multi-core optical fiber with the optical waveguide substrate, a minute V-shaped groove of a simple shape is formed on an intrinsically tabular surface is formed by the method of transferring the die having a minute V-shaped groove onto the plastic material. This technique is described to produce a V-groove member characterized by comparatively uniform thermal shrinkage, smaller residual stress and higher molding precision, but no specific mention is made on the method of improving molding precision.

In recent years, there is an active demand for downsizing of the reproduction and recording head and the slider constituting the head as a result of technological advances in the high-density information recording of the recording apparatus such as an HDD (hard Disk Driver). The size of the slider is standardized by the IDEMA (International Disk Drive Equipment and Materials Association). The sliders are called the mini slider, micro slider, nano slider, pico slider and femto slider in descending order of size. Of these sliders, those capturing the spotlight of the industry are the nano slider, pico slider and femto slider. The size and mass of these sliders are given in Table 1.

TABLE 1

| | Size | Mass |
|---|---|---|
| Names | (length × width × thickness; unit: mm) | (mg) |
| Nano slider | 2.05 × 1.60 × 0.43 | 5.5 |
| Pico slider | 1.25 × 1.00 × 0.30 | 1.5 |
| Femto slider | 0.85 × 0.70 × 0.23 | 0.5 |

In the high-density information recording, as can be seen from the size of the aforementioned sliders, the space is saved and more advanced high-density configuration is achieved by increasing the density of the information on each disk and arranging disks in multiple layers or storing them in a smallest possible enclosure. For example, when a multi-layer disk arrangement is assumed, intervals between disks are required to be minimized, and the thickness of the optical head including that of the slider shown in Table 1 is preferred not to exceed about 1.5 mm.

### SUMMARY

An object of the present invention is to solve the aforementioned problems and to provide an optical element characterized by high precision and easy manufacturing method, and an optical head using the same.

In view of forgoing, one embodiment according to one aspect of the present invention is an optical element which is to be mounted on a slider moving on a recording medium, comprising:

a portion defining a groove, a first end of which is open and a second end of which is closed; and

a deflection surface which deflects a light guided from a light source through the second end of the groove,

wherein the optical element is formed of a fluid material transparent to the light, and a thickness of the material constituting a bottom part of the groove is greater at the second end than at the first end.

According to another aspect of the present invention, another embodiment is an optical head, comprising:

an optical element, including:
a portion defining a groove, a first end of which is open and a second end of which is closed; and
a deflection surface which deflects a light guided from a light source through the second end of the groove, and

a slider which mounts the optical element thereon and moves above a recording medium,

wherein the optical element is formed of a fluid material transparent to the light, and a thickness of the material constituting a bottom part of the groove is greater at the second end than at the first end.

### BRIEF DESCRIPTION OF THE DRAWINGS

FIG. 1 is a drawing representing an example of the optical recording apparatus;

FIG. 2 is a cross sectional view representing an example of an optically assisted type magnetic recording head with a magnetic recording element mounted on the optical head;

FIG. 3 is a perspective view representing an example of the optical element contained in an optical head;

FIG. 4 is a cross sectional view showing an example of the structure of the optical head;

FIG. 5 is a perspective view showing an optical element contained in the optical head;

FIG. 6 is a cross sectional view showing an example of the structure of the optical head;

FIG. 7 is a perspective view showing an optical element contained in the optical head;

FIG. 8 is a perspective view showing a space to be filled with a fluid material when the die for molding the optical element is closed, and a gate through which resin is filled;

FIG. 9(A), FIG. 9(B) and FIG. 9(C) are diagrams showing the examples of an optical waveguide;

FIG. 10(A), FIG. 10(B) and FIG. 10(C) are diagrams representing the examples of a plasmon probe;

FIG. 11 is a perspective view showing a space filled with a fluid material when the die for molding the optical element is closed, and a gate through which resin is filled;

FIG. 12(a), FIG. 12(b) and FIG. 12(c) are diagrams schematically showing how the optical element is mounted on the slider; and

FIG. 13 is a perspective view showing the die for molding an optical element.

### DETAILED DESCRIPTION OF THE PREFERRED EMBODIMENT

The following describes the present invention with reference to the optically assisted type magnetic recording head having a magnetic recording element on the optical head as an illustrated embodiment, and the optical recording apparatus equipped therewith, without the present invention being restricted thereto. The same or corresponding portions in various embodiments will be assigned with the same numerals of reference, and will not be described to avoid duplication.

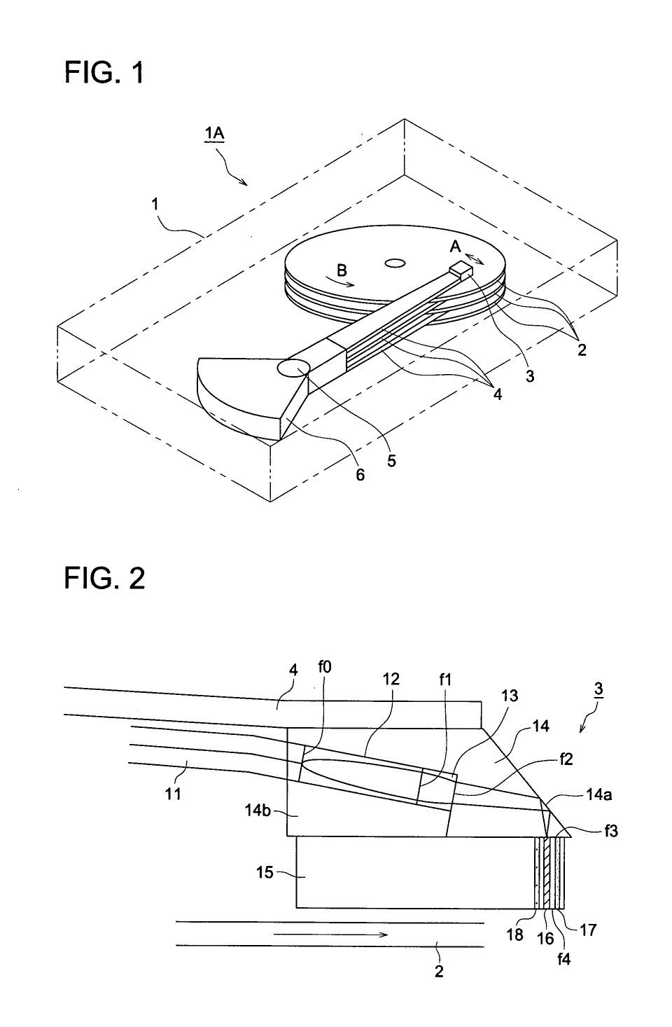

FIG. 1 shows an example of approximate structure of the optical recording apparatus (e.g., hard disk apparatus) provided with an optically assisted type magnetic recording head (hereinafter referred to as “optical head”) thereon. This optical recording apparatus 1A has an enclosure 1 incorporating:

a recording disk (magnetic recording medium) 2;

a suspension 4 arranged rotatably in the direction of the arrow mark A (direction of tracking) using a spindle 5 as a fulcrum;

a tracking actuator 6 mounted on the suspension 4;

an optical head 3 mounted on the front end of the suspension 4; and

a motor (not illustrated) for rotating the disk 2 in the direction of an arrow mark B.

This optical recording apparatus 1A is configured such that the optical head 3 can perform relative traveling in an floating state above the disk 2.

FIG. 2 is a cross sectional view showing an example of the optical head 3. The optical head 3 is an optical head that uses light to record information on the disk 2, and incorporates:

an optical fiber 11 as an linear light guide member for leading light to the optical head 3;

an optical element 14 further containing an optical waveguide 16 as an optical assist section for spot-heating of the recorded portion of the disk 2 by near-infrared laser beams; graded index lenses 12 and 13 as light-gathering elements for leading to the optical waveguide 16 the near-infrared laser beam emitted from the optical fiber 11; and a deflection surface 14a as an optical path deflecting section; and

a slider 15 further containing the aforementioned optical waveguide 16; a magnetic recording section 17 for writing the magnetic information onto the recorded portion of the disk 2; and a magnetic reproduction section 18 for reading the magnetic information recorded on the disk 2.

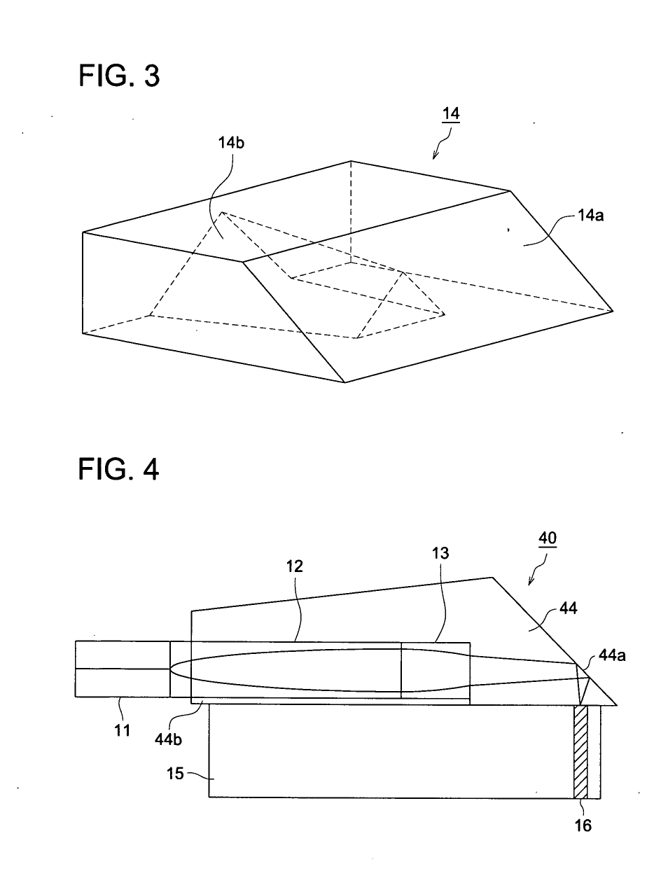

The optical element 14 is made up of a fluid material and is provided with a V-shaped groove (hereinafter referred to as “V-groove”) for fixing and bonding the optical fiber 11 and graded index lenses 12 and 13 as light-gathering elements. The V-groove is designed such that the thickness of the fluid material constituting the bottom thereof is greater on the side wherein the V-groove is closed, than on the side wherein it is open. FIG. 3 is a perspective view showing the optical element 14. The reference numeral 14b denotes a V-groove, and 14a indicates the deflection surface.

In FIG. 2, the magnetic reproduction section 18, optical waveguide 16 and magnetic recording section 17 are arranged in that order in the region from the incoming side of the recording area of the disk 2 to the outgoing side (marked by -> in the drawing), without the order of arrangement being restricted thereto. It is sufficient only if the magnetic recording section 17 is located immediately after the outgoing side of the optical waveguide 16. For example, the waveguide 16, magnetic recording section 17, magnetic reproduction section 18 can be arranged in that order.

The light led from the optical fiber 11 is the one emitted from the semiconductor laser, for example. The wavelength of this light is preferably the near-infrared wavelength of 1.2 μm or more (on the level of 0.8 μm through 2 μm for the near-infrared light band, and 1310 nm or 1550 nm as a specific wavelength of laser beam). The near-infrared laser beam coming from the end face of the optical fiber 11 is converted on the upper surface of the optical waveguide 16 arranged on the slider 15 by the graded index lenses 12 and 13 as light-gathering elements, and the optical element 14 having a deflection surface 14a. The light is led from the optical head 3 to the disk 2 through this optical waveguide 16.

The slider 15 makes a relative travel in a floating state to the disk as a magnetic recording medium. It may collide with the dust deposited on the medium or a defect on a medium if any. To minimize the wear that may be caused in such cases, the slider is preferably made of a hard material characterized by high wear resistance. For example, the ceramic material including the Al₂O₃, AlTiC, zirconia and TiN can be used. Further, to prevent wear, the disk 2 side of the slider 15 may be provided with surface treatment to improve wear resistance. For example, use of DLC (Diamond-like carbon) coating ensures a high degree of transmittance of near-infrared light and the greatest hardness (Hv=3000 or more) second to diamond.

The surface of the slider facing the disk 2 is provided with an air bearing surface (ABS) to enhance floating characteristics. Floating of the slider 15 must be stabilized where it is placed close to the disk 2. An appropriate amount of pressure for reducing the force of floating should be applied to the slider 15 when necessary. Thus, the suspension 4 fixed on the optical element 14 has a function of applying an appropriate pressure for controlling the force of floating of the slider 15, in addition to tracking the optical head 3.

When the near-infrared laser beam emitted from the optical head 3 has been applied to the disk 2 as a minute spot, there is a temporary rise of temperature at the portion of the disk 2 exposed to light so that the coercive force of the disk 2 is reduced. The magnetic information is written by the magnetic recording section 17 onto the exposed portion where the coercive force is reduced. The following describes this optical head 3:

In the first place, graded index lenses 12 and 13 constituting the light-gathering element will be described: The graded index lens (hereinafter referred to as “GRIN lens”) is a lens made of the medium of uneven refractive index (wherein the refractive index is greater closer to the center). It is a cylindrical lens that works as a lens by a continuous change in refractive index. The Si GRIN® (Silica Grin of Toyo Glass Co., Ltd.) can be mentioned as a specific example of the GRIN lens. The distribution n(r) of the refractive index in the radial direction of the GRIN lens can be expressed by the following formula (1):

n(r)=N0+NR2×r² (1)

wherein n(r) denotes the refractive index at distance r from the center, and N0 shows the refractive index at the center, and NR2 is the constant representing the converging capability of the GRIN lens. The GRIN lens has a distribution of the refractive index in the radial direction, and is characterized by easy alignment of the optical axis. This ensures easy alignment of the optical axes of the optical fiber 11, GRIN lens 12 and GRIN lens 13. When the optical fiber 11 is made of quartz, the material constituting the GRIN lens 12 and GRIN lens 13 is the same as that of the optical fiber 11. Accordingly, they can be subjected to melting treatment and can be bonded to form an integral body. This bondage ensures easy handling and reduces the loss of light on the surface wherein the optical fiber 11, GRIN lens 12 and GRIN lens 13 are in contact, with the result that the light led by the optical fiber is effectively emitted from the GRIN lens 13.

The light-gathering element made of the GRIN lens 12 and GRIN lens 13 converges the light led by the optical fiber 11, to the position away from the light emitting surface of the GRIN lens 13, whereby an optical spot is formed. The NAs (numerical apertures) of the GRIN lens 12 and GRIN lens 13 are different from each other. Respective lengths are determined properly by selection or combination of the GRIN lens 12 and GRIN lens 13, whereby the length occupied by the optical element, and the distance from the light emitting surface of the optical element to the optical spot can be determined.

The diameter of the GRIN lens 12 and GRIN lens 13 and the diameter of the optical fiber 11 are preferably the same with each other in the range of about ±10%. As described above, the optical fiber 11, GRIN lens 12 and GRIN lens 13 are bonded to each other by melting. Accordingly, when they have the same diameter, bondage work by alignment of the diameter centers can be done easily.

When the optical fiber 11, GRIN lens 12 and GRIN lens 13 are bonded together into an integral body (hereinafter referred to as “bonded light-gathering element”), the light led from the light source by the fiber 11 can be used to form an optical spot effectively at a site away from the light emitting end face of the GRIN lens 13. This bonded light-gathering element is fixed and bonded along the bottom of the V-groove 14b arranged on the optical element 14 of FIG. 3, and with the end face of the GRIN lens 13 kept in close contact with the closed end of the V-groove. The V-groove 14b is arranged with consideration given to the diameter of the bonded light-gathering element to be fixed, the position of light emitted from the bonded light-gathering element, the distance from the deflection surface 14a, and the incident angle of light from the light-gathering element. Thus, as described above, easy high-precision mounting can be achieved by ensuring that the bonded light-gathering element can be fixed along the V-groove 14b. Further, the light led from the light source by the fiber 11 is formed into convergent light by the light-gathering element GRIN lens 12 and GRIN lens 13, and light flux is deflected by the deflection surface 14a, whereby an optical spot can be effectively formed on the lower surface of the optical element 14.

As described above, when a light-gathering element containing the GRIN lenses 12 and 13 is provided between the optical fiber 11 and deflection surface 14a, the aforementioned bonded light-gathering element can be provided almost parallel to the direction wherein the optical head 3 travels in an floating state, assuming, for example, that the deflection angle in the deflection surface 14a is 90°. This arrangement eliminates the need of arranging the light-gathering element along the height of the optical head, and hence allows the optical head to be made thinner. This contributes the downsizing of the optical head.

The optical element 14 is preferably made of a thermoplastic resin or glass as a fluid material, and is preferably formed by the injection molding method or press method. For example, the Si suited for micromachining can be processed by photolithographic treatment and etching to get the same shape as that of the optical element 14. However, since the manufacturing process is the same as that of the semiconductor, the manufacturing process is complicated.

The injection molding method or press method characterized by excellent volume production efficiency can obtain the optical element 14, using a fluid material instead of Si. Further, as compared with the method of production by photolithographic treatment and etching using Si as a material, the method of manufacturing the optical element 14 by the molding technique using the fluid material provides a high degree of freedom, and ensures easy production through proper setting of the shape of the V-groove, the inclination of the groove and angle of the reflected surface. The thermoplastic resin as a fluid material that can be formed in this manner is exemplified by ZEONEX® 480R (refractive index: 1.525; made by Nippon Zeon Co., Ltd.); PMMA (polymethyl methacrylate, for example, Sumipex® MGSS, refractive index: 1.49; made by Sumitomo Chemical Co., Ltd.)); and PC (polycarbonate, for example, Panlite® A D5503, refractive index: 1.585; made by Teijin Chemical Co., Ltd.). Further, glass as a fluid material is exemplified by the SF6 (nd=1.805, vd=25.40) as the glass having a high refractive index glass used in glass molding. And it is exemplified by the PG375 (Vidron, made by Sumida Optical d=1.54250, vd=62.9) as an optical glass for a molded lens that can be molded at a very low temperature, when consideration is given to the service life of the die.

When the optical element 14 containing the reflected surface 14a and V-groove 14b shown in FIG. 3 is molded using the fluid materials exemplified above, as shown in FIG. 3. The thickness of the bottom of the V-groove 14b for fixing the bonded optical element is greater on the side wherein the V-groove 14b is closed, than on the side wherein it is open.

When the optical element 14 is manufactured, the surface requiring particularly high optical precision is the deflection surface 14a. For example, if deformation such as surface distortion or waviness has occurred to this deflection surface 14a, the light flux that enters this deflection surface 14a to be deflected does not form uniformly convergent flux. Thus, an optical spot of higher incoming efficiency cannot be formed on the incident surface of the optical waveguide 16 arranged on the lower surface of the optical element 14.

Generally, it is important in the injection molding method to ensure that the fluid material is sufficiently charged without a gap being formed in the corners of the space formed by the die. As the space formed by the die is smaller, the sectional area wherein the fluid material can flow is reduced. It becomes more difficult to charge the fluid material without gap.

The optical element of the present invention is very small such that its size is 1 mm×1 mm, and its thickness is 0.5 mm or thereabout, for example. The present inventors have made efforts to study the structure of the aforementioned minute optical element wherein the surface shape is optically satisfactory without any portion where a fluid material is uncharged, and have found out an optical element characterized by the satisfactory surface 14a and no charging failure of fluid materials.

To put it more specifically, as shown in FIG. 3, the thickness of the fluid material forming the bottom of the V-groove 14b is made greater on the side wherein the V-groove 14b is closed than on the side wherein it is open. In the cross section of the bottom portion of the V-groove 14b along the V-groove 14, this arrangement ensures that the sectional area is greater on the side wherein the V-groove 14b is closed than on the side wherein it is open. The greater size of the sectional area on the closed side reduces the resistance to the flow of the fluid material. Thus, easy flow of the fluid material is achieved on the closed side.

The portion wherein the thickness of the fluid material is smaller is likely to be subjected such defects as insufficient charging of fluid material or insufficient pressure at the time of resin supply. This increases the optical distortion that causes birefringence or insufficient surface precision. The problem tends to occur most frequently where the thickness of the fluid material is the smallest. From the viewpoint of precision, it is important to ensure that the position requiring high precision will not be close to where the thickness of the fluid material is the smallest. Thus, in the optical element 14, the thickness is made greater on the side wherein the V-groove 14b is closed than on the side wherein it is open, so that the flowability of the fluid material around the deflection surface 14a located on the side wherein the V-groove is closed at the time of forming the optical element 14 can be achieved. This arrangement provides an optical element 14 characterized by excellent optical properties.

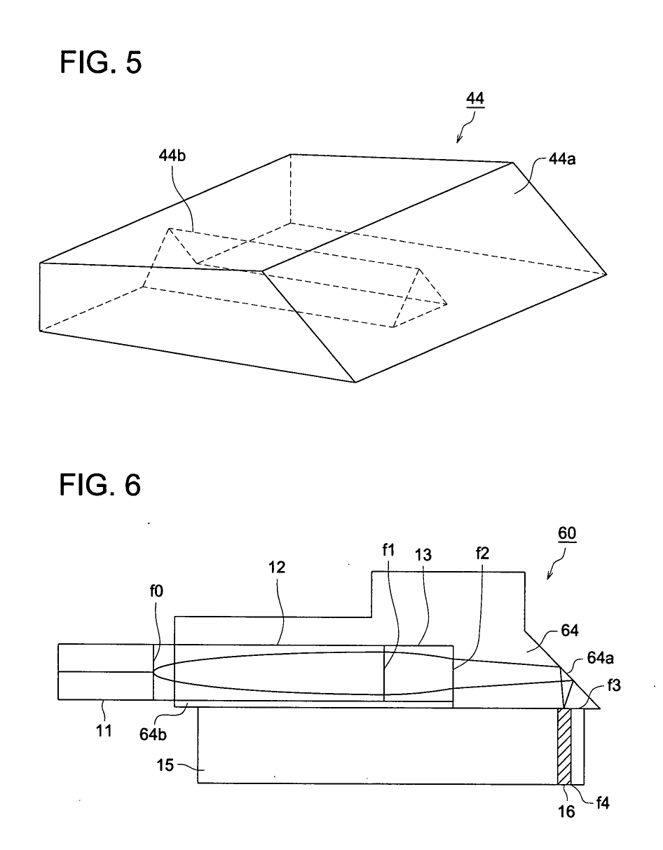

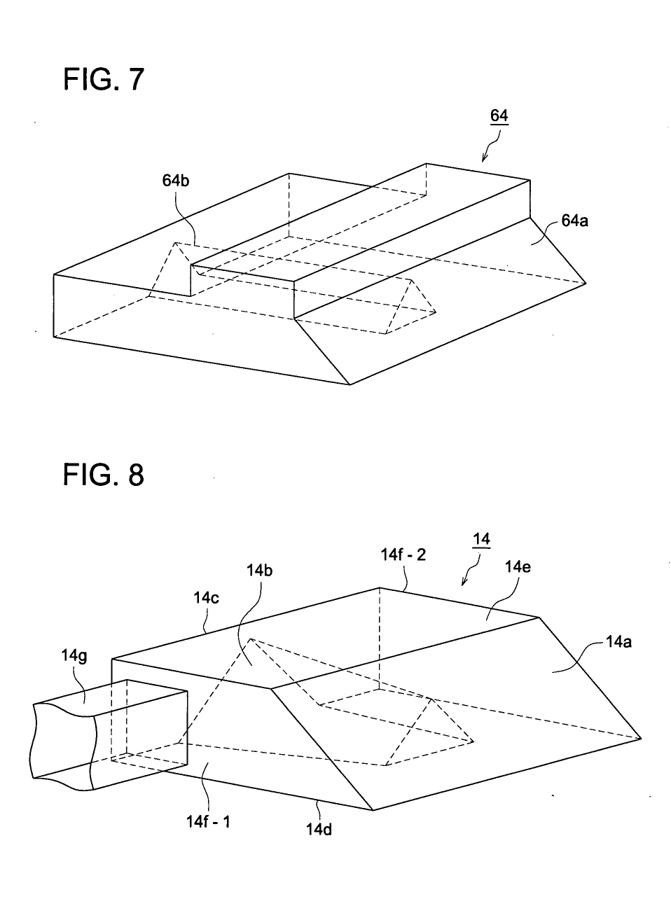

The following describes the examples of the structure wherein the thickness of the fluid material forming the bottom of the V-groove is greater on the side wherein the V-groove is closed than on the side wherein it is open: As shown in FIG. 3, while the upper surface of the optical element 14 is flat, the V-groove 14b is tilted. In addition to this structure, for example, as in the case of the optical head 40 (FIG. 5 showing the perspective view of the optical element 44) shown in FIG. 4, the depth of the V-groove 44b is kept constant and the upper surface of the optical element 44 is made higher on the side wherein the V-groove 44b is closed. Further, as in the case of the optical head 60 (FIG. 7 showing the perspective view of the optical element 64) shown in FIG. 4, the depth of the V-groove 64b is kept constant, and the upper surface of the optical element 64 is higher on the side wherein the V-groove 44b is closed, or the aforementioned V-groove 64b is tilted, and the upper surface of the optical element 64 is tilted or a step structure is formed. A combination of such structures can be used.

As shown in FIG. 2, when the upper surface of the optical element is made almost parallel to that of the disk 2, the V-groove for fixing the bonded light-gathering element is arranged in a tilted position, and accordingly, the incident angle with respect to the deflection surface 14a can be increased. When the optical element 14 is made of resin, the refractive index is as low as about 1.5 as compared with an optical glass having a high refractive index of about 1.7. Thus, the total reflection angle is increased on the deflection surface 14a. For example, when the ZEONEX® having a refractive index of 1.525 is used as the resin forming the optical element, the full reflection angle will be about 42°. When the light deflection angle by the deflection surface 14a is 90° (the incident angle to the deflection surface being 45°), then the light is fully reflected if the light flux converging within ±3° is applied. When the light flux having a greater incident angle width is applied, part of the light passes through the deflection surface 14a without being reflected, and goes outside. This will cause reduction in reflection efficiency. Accordingly, the V-groove fixing the bonded light-gathering element is tilted, whereby the incident angle to the deflection surface 14a can be increased to provide a structure that facilitates total reflection of light. For example, as shown in FIG. 2, when the V-groove is tilted 10°, the incident angle to deflection surface 14a is 50°. An allowance of 8° is available up to the angle of 42° wherein total reflection occurs, and therefore, the incoming light flux having greater width can be fully reflected, with the result that reflection efficiency is enhanced.

Further, when the refractive index of the fluid material forming the optical element 14 is increased, the light emitted from the optical element 14 can be led to the optical waveguide 16 with greater efficiency. The light coming from the bonded light-gathering element enters the optical element made of the fluid material and is deflected by the deflection surface, thereby forming an optical spot on the lower surface of the optical element. Assuming that the full incident angle of the light flux forming this optical spot is θ, the numerical aperture (NA) for emission forming the optical spot can be given by the following formula (2):

NA=n×sin θ (2),

wherein “n” denotes the refractive index of the fluid material forming the optical element, and “θ” represents the full incident light of the light flux forming the optical spot. As shown in the formula (2), the NA is greater than that when air is used as the medium through which the light flux forming the optical spot passes, by the amount gained by multiplication of about “n” (refractive index). This makes it possible to reduce the diameter of the optical spot to be formed, and hence, enhances the efficiency wherein the light coming from the optical element 14 is led to the optical waveguide 16.

As shown in FIG. 2, the structure is preferably designed such that the V-groove 14b for fixing the bonded light-gathering element has an aperture on the lower surface of the optical element 14, and the bonded light-gathering element is fixed on the upper side serving as the bottom of the V-groove 14b. The optical head 3 should be connected, for example, with the suspension 4 that holds it above the disk 2, and the optical head 3 should be provided with a space for connection with the suspension 4. The structure wherein the optical head 3 is held from the lower side is difficult to achieve because the slider 15 with a floating mechanism for permitting relative traveling in a floating state over the disk 2 is required to be attached. The structure wherein the suspension 4 is sandwiched between the optical element 14 and slider 15 needs to include an aperture of the V-groove 14b that holds the bonded light-gathering element, and this makes it necessary to circumvent the aperture of the V-groove 14b. Further, the light flux converged on the optical waveguide 16 must also be circumvented. Thus, when the suspension 4, for example, is to be fixed at the center of the optical element 14 in the direction of relative traveling on the recording surface, the suspension 4 cannot be fixed at the center of the optical element 14 along the V-groove 14b, and this makes it difficult to ensure balanced holding.

Accordingly, when the bonded light-gathering element is held from the upper side of the optical element 14, the suspension 4 can be fixed on the upper surface of the optical element 14. The upper surface of the optical element 14 is a flat surface free from any roughened structure such as a V-groove, and has a large degree of freedom for mounting the suspension 4. The suspension 4 can be fixed on the optical element 14 kept in balance to ensure that the optical head 3 is stably floating on the disk 2. Further, the flat configuration can be utilized to set a positioning mark, which facilitates the installation on the upper surface of the optical element 14, for connection with the suspension 4, for example. Further, since there is a short distance between the suspension 4 and optical fiber 11 for leading light from the light source, the optical fiber 11 can be easily fixed along the suspension 4.

FIG. 8 is a perspective view showing the space (cavity) filled with the fluid material when the die for molding the optical element 14 is closed, and the gate through which the fluid material is filled.

FIG. 13 shows an example of a die provided with a space (cavity) having the reverse form of the optical element 14 of FIG. 8 and a gate for filling with resin. The M1 indicates the first die and the M2 shows the second die. When these two dies are closed, resin is supplied through the gate section G1, whereby the optical element 14 is molded. In the first die M1, the M1-1 is the surface for molding the deflection surface 14a. The M1-2 and M1-3 are the surfaces for molding the surfaces 14f-2 and 14f-1, respectively. The M1-4 is the surface for molding the surface 14e, and the M1-5 is the surface for molding the surface 14c. In the second die M2, the M2-1 is the surface used to mold the V-groove 14b, and the M2-2 is the surface used to mold the surface 14d.

When the optical element 14 is molded according to injection molding method, the gates as fluid material supply ports in the molding die are preferably arranged on the surfaces 14f-1 or 14f-2, not the deflection surface 14a, the surface 14d in which the V-groove 14b has an aperture, the surface 14e on the side opposite to the surface 14d in which the V-groove 14b has the aperture, or the surfaces 14c in which the V-groove 14b is open, as shown in FIG. 8.

As shown in FIG. 8, the surface provided with the gate 14g is not the deflection surface 14a, which optically requires high precision, of the optical element 14 formed by molding, the surface 14e fixed with the suspension 4, or the surface 14d provided with the slider 15. Further, the surface provided with the gate 14g is not the surface 14c (surface wherein the V-groove is opened) facing the deflection surface 14a, but the lateral surface perpendicular to the deflection surface 14a. Thus, this arrangement does not allow the so-called weld-line to be formed on the deflection surface 14a, wherein the weld-line would be produced when the fluid material supplied from the gate would be separated into several branches to enter the cavity of the die, and the branched fluid materials would meet on the opposite side. Accordingly, assuming that the surface provided with the gate 14g is surface 14f-1 or surface 14f-2, this arrangement preferably eliminates all problems when the slider 15 or suspension 4 is fixed on the optical element 14, or satisfactory deflection surface 14a is provided.

The thickness of the optical element 14 is preferably 0.1 mm or more without exceeding 1 mm. If the thickness is kept within this range, the die can be filled with a sufficient amount of fluid material. This provides the advantage of ensuring satisfactory molding operation by using the structure wherein the thickness on the bottom of the V-groove is greater on the side wherein the V-groove is closed than on the side wherein it is open. Further, the dimensions (length L, width W) in the direction perpendicular to the thickness of the optical element 14 preferably meet the conditional formulas (3a) and (3b) with respect to the dimensions (length b, width c) of the slider carrying the optical element shown in Table 1:

b<L≦k×b (3a)

c<W≦k×c (3b),

wherein “k” is a coefficient representing 2; “b” denotes the length of the slider carrying the optical element, in the direction wherein the slider travels; “c” indicates the width of the slider carrying the optical element, in the direction perpendicular to the direction wherein the slider travels; “L” shows the length of the optical element in the same direction as “b”; and “W” indicates the width of the optical element in the same direction as “c”.

As shown in FIG. 8, if a gate is arranged on the surface of the die for forming the surfaces 14f-1 and 14f-2 of the optical element 14, an inject pin for removing the molded optical element 14 from the die is installed on the side of the surface 14e in some case. In this case, the inject pin is normally installed perpendicular to the gate. It depends on where the V-groove of the optical element 14 is located.

If the optical element 14 is formed according to this die structure, a burr may be produced around the lower surface of the optical element 14. If a burr is produced on the lower surface of the optical element 14, a protrusion will be present on the mounting surface when the optical element 14 is mounted on the slider 15. When the surface for mounting the optical element 14 on the slider 15 is of the same size or is smaller than the surface of the slider 15 for mounting, the surface bonding between the optical element 14 and slider 15 may become loose or the surface may be tilted.

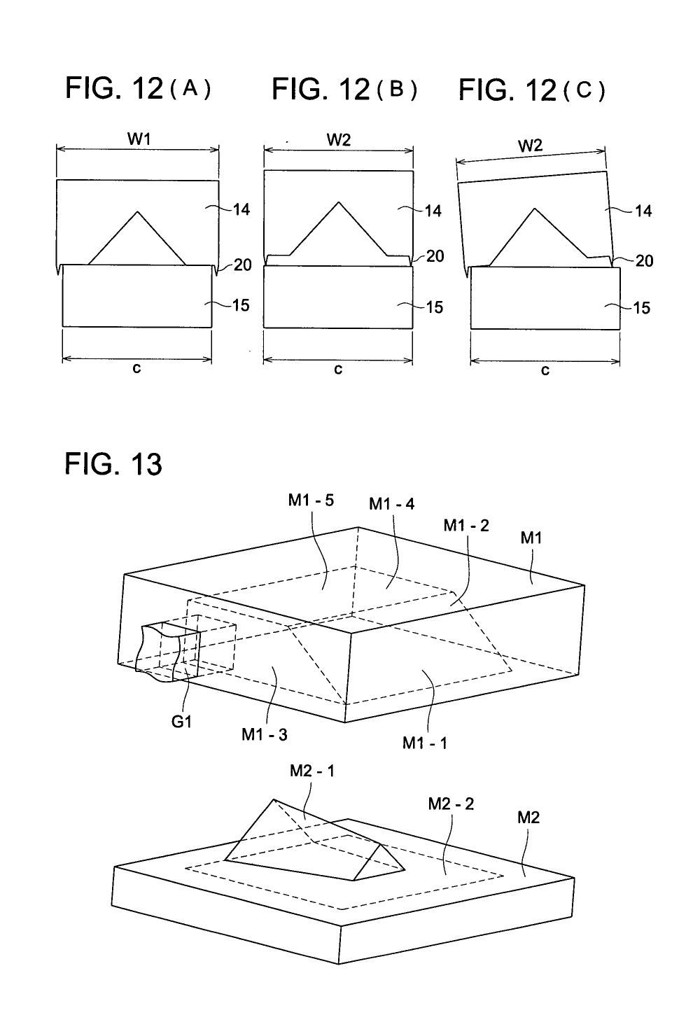

This is illustrated in FIG. 12(a), FIG. 12(b) and FIG. 12(c). The reference numeral 20 indicates a burr. FIG. 12(a) shows the case wherein the width W1 of the optical element 14 is greater than the width c of the slider 15. In this case, the optical element 14 can be mounted correctly on the slider 15. FIG. 12(b) and FIG. 12(c) show the case wherein the width W2 of the optical element 14 is smaller than the width c of the slider 15. In this case, the optical element 14 and slider 15 may be loosely connected, or may be mounted in a tilted position. Thus, the optical element 14 is preferably made greater than the slider 15, because the slider 15 can be accurately mounted on the lower surface of the optical element 14 without the need of removing burrs.

If a resin is used as the fluid material used to mold the optical element 14, the weight can be reduced, but Si has a specific gravity of about 2.4, and the resin has a specific gravity of about 1 (for example, ZEONEX® 480R made by Nippon Zeon Co., Ltd. has a specific gravity of 1.04 according to the catalog of this company). Accordingly, if the size is excessive, the weight cannot be reduced as compared to the mass of the optical element made up of Si having the equivalent function as that of the optical element made of resin, although it depends on the thickness of the optical element 14. For example, for the size of the optical element (assumed to have a square) made up of the ZEONEX® 480R having the same mass as that of the optical element made of Si having the same thickness, the optical element of ZEONEX® 480R has a size of about 1.4, assuming that the size of the optical element made of Si is 1. Accordingly, the coefficient k in the conditional formulas (3a) and (3b) that define the upper limit of the size is 2, preferably 1.5, more preferably 1.2.

Accordingly, the dimensions (length L, width W) in the direction perpendicular to the thickness of the optical element 14 meet the conditional formulas (3a) and (3b), and an appropriate fluid material is selected, whereby the optical element characterized by light weight and easy accurate assembling can be obtained.

It is preferred that the position where an optical spot is formed by the light-gathering element including the GRIN lenses 12 and 13 should be determined as the upper surface of the slider 15, and an optical waveguide 16 should be installed immediately below. Installation of the optical waveguide 16 allows the optical spot converging on the upper surface of the slider 15 to be effectively led to the lower surface of the slider 15, without the spot diameter being adversely affected. The direction of the light converging into the optical waveguide 16 is preferably almost perpendicular to the incident surface of the optical waveguide 16. As the light deviates from the perpendicular direction, the efficiency of wave guiding by the optical waveguide 16 will be lower. When the light has deviated about 30°, there is almost no wave guiding. When the light is perpendicular within the deviation of about ±10°, effective wave guiding can be provided.

Further, there is no need of ensuring that the convergent light having an angle passes through the slider 15. Accordingly, the magnetic recording section 17 and magnetic reproduction section 18 can be easily mounted, close to, and before or after, the optical waveguide 16 in the direction wherein the magnetic recording surface makes a relative travel.

Further, when the optical waveguide 16 has the optical spot size changing function (to be described later), the diameter of the optical spot formed on the incident surface of the optical waveguide 16 can be reduced on the outgoing surface with respect to the diameter on the incident surface of the optical waveguide 16. Thus, a smaller diameter of the optical spot can be formed on the recording medium surface, thereby meeting the requirements for higher recording density.

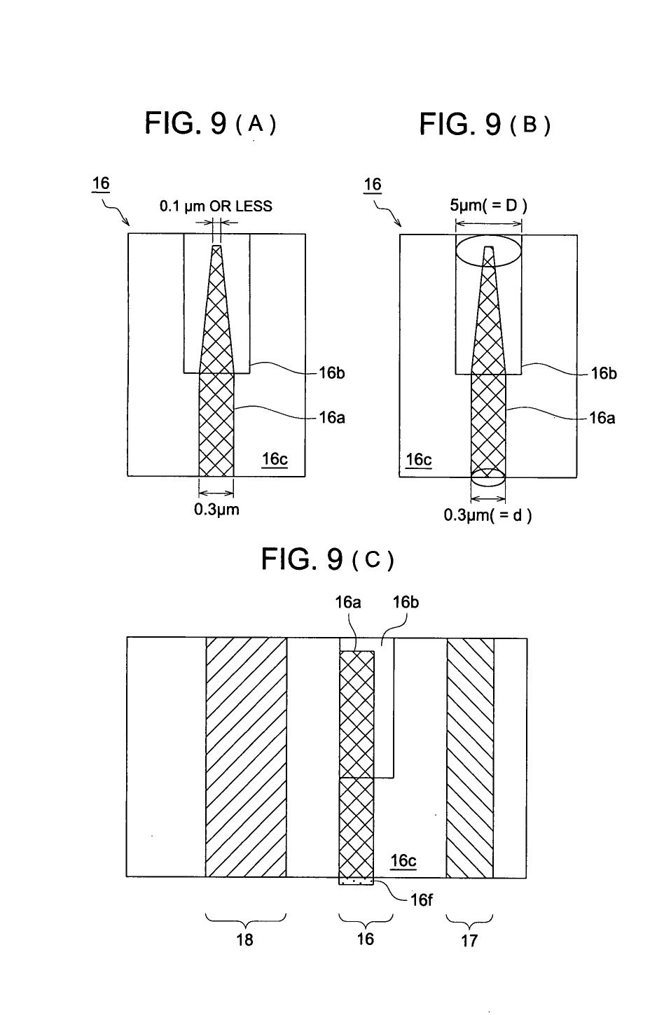

FIG. 9(A), FIG. 9(B) and FIG. 9(C) show the examples of the optical waveguide having an optical spot size changing function. FIG. 9(A) and FIG. 9(B) shows the portion of the optical waveguide as viewed from the direction wherein the optical head makes a relative travel. FIG. 9(C) schematically shows the portion of the optical waveguide as viewed from the direction perpendicular to the traveling direction and parallel to the magnetic recording surface.

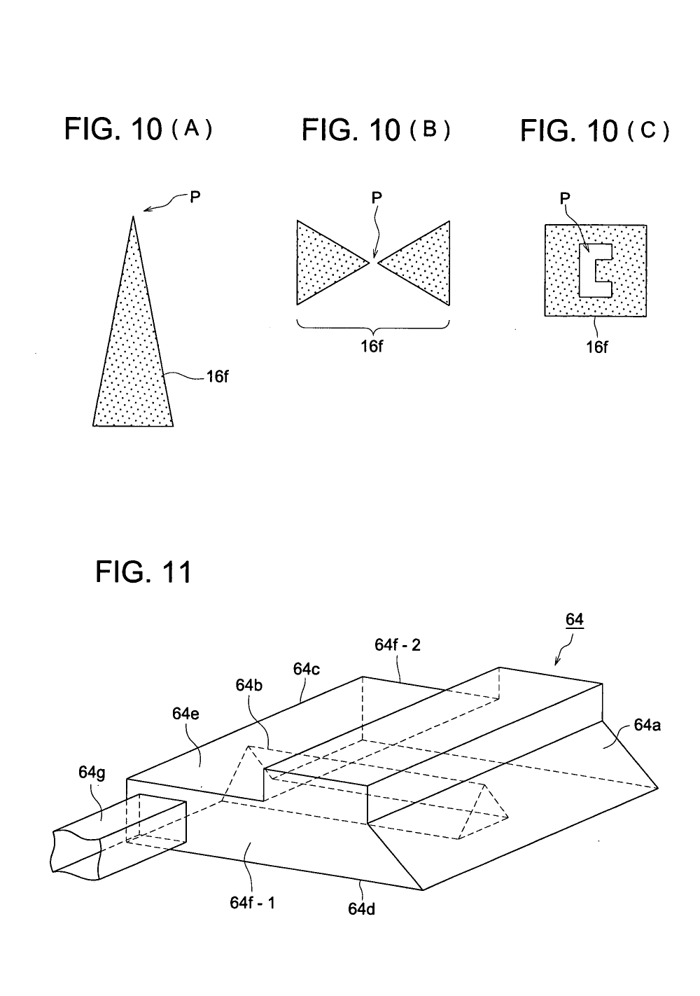

The optical waveguide shown in FIG. 9(A), FIG. 9(B) and FIG. 9(C) is made up of a core 16a (e.g., Si), sub-core 16b (e.g., SiON) and clad 16c (e.g., SiO₂). As shown in FIG. 9(C), the plasmon probe 16f for generating near-field light is arranged at the position wherein the optical waveguide emits light or close to that position. Specific examples of the plasmon probe 16f are shown in FIG. 10(A), FIG. 10(B) and FIG. 10(C).

Of FIG. 10(A), FIG. 10(B) and FIG. 10(C), FIG. 10(A) shows a plasmon probe 16f made of a triangular tabular metallic thin film (material exemplified by aluminum, gold and silver), and FIG. 10(B) shows a plasmon probe 16f made of the bow tie type tabular metallic thin film (material exemplified by aluminum, gold and silver). They have an antenna having a vertex P with a curvature radius of 20 nm or less. FIG. 10(C) shows a plasmon probe 16f made of a tabular metallic thin film having an aperture (material exemplified by aluminum, gold and silver), and contains an antenna having an vertex P with a curvature diameter of 20 nm or less. When light acts on these plasmon probes 16f, near-field light is produced close to the vertex P, and recording or reproduction can be performed using the light of very small spot size. To be more specific, when a plasmon probe 16f is arranged at the light emitting position of the optical waveguide or in the vicinity thereof, a local plasmon is generated. This arrangement reduces the size of the optical spot formed by the optical waveguide. This arrangement is preferably used for high-density recording. It should be noted that the vertex P of the plasmon probe 16f is preferably located at the center of the core 16a.

According to the optically assisted method, the spot diameter required for extra-high density recording is about 20 nm. When consideration is given to the efficiency of using light, the mode field (MFD) in the plasmon probe 16f is preferably about 0.3 μm. Since the size of this MFD does not allow entry of light, the spot diameter must be reduced to a few hundred nm from about 5 μm by the spot size changing function.

In FIG. 9(A), FIG. 9(B) and FIG. 9(C), the width of the core 16a is constant from the light input side to the light output side according to the cross section of FIG. 9(C). However, the width of the core 16b exhibits a gradual increase in the sub-core 16b from the light input side to the light output side according to the cross section of FIG. 9(A). The mode field diameter is converted by this smooth change in the diameter of the optical waveguide. To be more specific, the width of the core 16a of the optical waveguide is 0.1 μm or less on the light input side as shown in FIG. 9(A), and is 0.3 μm on the light output side. However, as shown in FIG. 9(B), the optical waveguide with a MFD of about 5 μm is formed by the sub-core 16b on the light input side, and is gradually light-coupled with the core 16a thereafter so that the mode field diameter is reduced. In this way, assuming that the mode field diameter on the light output side of the optical waveguide is “d”, and the mode field diameter on the side of the light input side of the optical waveguide is “D”, the mode field diameter is preferably changed by smooth change of the diameter of the optical waveguide so that D>d can be met.

The optical head discussed above is an optically assisted type magnetic recording head that uses light to record information on the disk 2. It can be an optical head that uses light to record information on the recording medium, for example, an optical head that performs recording such as optical recording in the near-field optical or phase change recording without having any magnetic reproduction section 17 or magnetic recording section 18. Further, the aforementioned plasmon probe 16f can be placed where light is emitted from the optical waveguide 16, or at the nearby position.

According to the optical element of the present invention, the optical element is made of a fluid material and the thickness of the fluid material forming the bottom of the groove is greater on the second end than on the first end. A deflection surface for deflecting light is provided on the second end.

When an optical element is formed using a die, for example, there is a large sectional area on the second end wherein a fluid material travels than on the first end. Thus, the flowability of the fluid material is superior on the second end than on the first end of the groove. The deflection surface on the second end can be formed effectively by molding.

Further, it is possible to configure an optical head containing the aforementioned optical element and the slider traveling on the recording medium.

Thus, this method provides an optical element characterized by high precision and excellent performance of volume production, and an optical head using this optical element.

### EXAMPLE

The following describes the Examples of the present invention:

The common conditions in the following Examples 1 through 5 will be shown below: The following again describes the formula (1) representing the refractive index of the GRIN lens wherein the wavelength used is 1.31 μm.

n(r)=N0+NR2×r² (1),

wherein “r” shows the distance from the center (radial distance from the center).

The following shows the constant required for the aforementioned formula (1) to represent the refractive index of the GRIN lens A and GRIN lens B as the graded index lenses used in the following Examples 1 through 5.

GRIN lens A

NA=0.166 (Examples 1 through 4), 0.156 (Example 5)

N0=1.479606

NR2=−2.380952 GRIN lens B

NA=0.395 (Examples 1 through 4), 0.372 (Example 5)

N0=1.540737

NR2=−12.47619

The GRIN lens A and GRIN lens B have diameters of 85 μm (Examples 1, 2 and 4), 125 μm (Example 3), and 80 μm (Example 5). The slider 15 is made of AlTiC, and has a length (traveling direction) of 0.85 mm, a thickness (direction of levitation) of 0.23 mm, and a width (depth) of 0.7 mm. The optical fiber has diameters of 85 μm (Example 1, 2 and 4), 125 μm (Example 3), and 80 μm (Example 5).

In the following Examples, no magnetic recording section, magnetic reproduction section or plasmon probe is provided. Needless to say, they can be provided when the optically assisted type magnetic recording head is used or extra-high density recording is performed.

The bonding surfaces on the optical path of FIG. 2 and FIG. 6 and the final end face are assigned with reference numerals f0, f1, f2, and so on. They respectively correspond to the virtual light source, surface 1, surface 2, and so on, which represent the surface items shown in the Tables corresponding to the Figures described with reference to the following Examples. In the Examples 1 through 5, resin is used as the fluid material.

### Example 1

In FIG. 2, the reference numeral 3 denotes an optical head, 11 an optical fiber, 12 a GRIN lens (GRIN lens A), 13 a GRIN lens (GRIN lens B), 14 an optical element in which a 10-degree tilted V-groove 14b and deflection surface 14a are integrated into one piece, 15 a slider, and 16 an optical waveguide. FIG. 3 is a perspective view representing the optical element 14.

In FIG. 2, the optical element 14 provided with the V-groove 14b is fixedly bonded on the slider 15. The optical element 14 has a length (traveling direction) of 1.25 mm, a thickness (direction of levitation) of 0.5 mm, a width (depth) of 1 mm, and an angle of 50° in the deflection surface 14b. The vertical angle of the V-groove 14b is 80°, and the depression angle declining to the deflection surface 14a is 10°. The thickness of the bottom of the V-groove 14b is 0.16 mm at the open end, and 0.32 mm at the closed end, so that the bottom of the V-groove 14b has a greater sectional area at the closed end than at the open end. This optical element 14 was manufactured using the space (cavity) having a shape reverse to that of the optical element 14 of FIG. 8 and the injection molding die of FIG. 13 equipped with a resin charging gate. The resin used is the ZEONEX® 480R (made by Nippon Zeon Co., Ltd., having a refractive index of 1.525) as a thermoplastic resin.

In the V-groove 14b of the optical element 14, the end face of the GRIN lens 13 is pressed against and fixedly bonded to the closed end face of the V-groove 14b of the optical element 14 without an air layer between the surfaces while the optical fiber 11, GRIN lens 12 and GRIN lens 13 are connected into one integral piece by a process of melting.

The light flux coming out of the optical fiber 11 having a diameter of 85 μm is formed into a parallel light flux by the GRIN lens 12 having a length of 0.595 mm. The parallel light is converted into convergent light through the GRIN lens 13 with a length of 0.085 mm and is launched into the optical element 14 wherein the deflection surface 14a has an angle of 50°.

Thus, the incident angle with respect to the deflection surface 14a is 50°. The light flux having been deflected to about 100° on the deflection surface 14a is converged almost perpendicularly to the incoming end face of the optical waveguide 16 to form a satisfactory optical spot, whereby optical coupling is performed. When the angle for deflecting the light flux by the deflection surface is set to 100°, the reflection on the deflection surface 14a of the optical element made of the ZEONEX® 480R having a smaller refractive index can be made closer to the full reflection. Further, when the V-groove 14b is tilted 10°, light enters in the direction perpendicular to the incident surface of the optical waveguide 16, with the result that light efficiency is enhanced. The mode field diameter of the optical fiber 11 is about 10 μm, and that of the optical waveguide 16 is also about 10 μm. The light emitted from the optical fiber 11 can be formed into the optical spot capable of meeting the mode field diameter of the optical waveguide 16 by the combination of the GRIN lens 12 and the GRIN lens 13. The magnification of this optical system can be 1:1.

Table 2 shows numerical values related to the GRIN lens 12 (GRIN lens A), the GRIN lens 13 (GRIN lens B) and the optical element 14:

TABLE 2

| | | Axial | |
|---|---|---|---|
| | Curvature | surface distance | Refractive |
| Surface | radius | (mm) | index |
| Virtual light source | ∞ | 0 | — |
| 1 | ∞ | 0.595 | See GRIN lens A |
| 2 | ∞ | 0.085 | See GRIN lens B |
| 3 | ∞ | 0.247872 | 1.525 |
| 4 | ∞ | — | — |

### Example 2

In FIG. 6, the reference numeral 60 denotes an optical head, 11 an optical fiber, 12 a GRIN lens (GRIN lens A), 13 a GRIN lens (GRIN lens B), and 64 an optical element formed by integration of the V-groove 64b and deflection surface 64a. The reference numeral 15 indicates a slider, and 16 is an optical waveguide. FIG. 7 is a perspective view of the optical element 64.

FIG. 11 is a perspective view showing the space (cavity) which is filled with resin when the die for molding the optical element 64 is closed, and the gate through which resin is supplied.

As shown in FIG. 11, the gate 64g as a resin inlet in the die for molding the optical element 63 using a resin according to the injection molding method is arranged on the surface 64f-1 out of the surfaces 64f-1 and 64f-2, not on the deflection surface 64a, a surface 64d in which the V-groove 64b has an aperture, the surface 64e on the side opposite the surface 64d in which the V-groove 64b has the aperture, or the surface 64c to which the V-groove 64b is open.

In FIG. 6, the optical element 64 is fixedly bonded on the same slider 15 as that in the Example 1. The optical element 64 has a length (traveling direction) of 1.25 mm, a thickness (direction of levitation) of 0.5 mm (0.34 mm on the lower step), a width (depth) of 1 mm, and the angle of deflection surface 64a of 45°. The V-groove 64b has a vertical angle of 80°, and is almost parallel with the lower surface of the optical element 64. The bottom of the V-groove 64b has a thickness of 0.16 mm on the open end and 0.32 mm (length 0.35 mm, width (depth) 1 mm) on the closed end, the latter value being greater by the thickness of the step. Thus, the sectional area is made greater on the side wherein the V-groove is closed, than on the side wherein it is open. The optical element 64 was molded with an injection molding die provided with a space (cavity) having the reverse form of the optical element 64 of FIG. 11 and a gate for filling with resin. The resin used is the ZEONEX® 480R (made by Nippon Zeon Co., Ltd., with a refractive index of 1.525) which is a thermoplastic resin.

In the V-groove 64b of the optical element 64, the end face of the GRIN lens 13 is pressed against and fixedly bonded to the closed end face of the V-groove 64b of the optical element 64 without an air layer between the surfaces while the optical fiber 11, GRIN lens 12 and GRIN lens 13 are connected into one integral piece by a process of melting.

The light flux coming out of the optical fiber 11 having a diameter of 85 μm is formed into a parallel light flux by the GRIN lens 12 having a length of 0.595 mm. The parallel light is converted into convergent light through the GRIN lens 13 with a length of 0.085 mm and is launched into the optical element 64 wherein the deflection surface has an angle of 45°.

Thus, the incident angle with respect to the deflection surface 64a is 45°. The light flux having been deflected to about 90° on the deflection surface 64a is converged almost perpendicular to the incoming end face of the optical waveguide 16 to form a satisfactory optical spot, whereby optical coupling is performed. The mode field diameter of the optical fiber 11 is about 10 μm, and that of the optical waveguide 16 is also about 10 μm. The light emitted from the optical fiber 11 can be formed into the optical spot capable of meeting the mode field diameter of the optical waveguide 16 by the combination of the GRIN lens 12 and the GRIN lens 13. The magnification of this optical system can be 1:1.

The numerical values related to the GRIN lens 12 (GRIN lens A), the GRIN lens 13 (GRIN lens B) and the optical element 64 are the same as those given in Table 2.

### Example 3

The diameter of the optical fiber 11, GRIN lens 12 and GRIN lens 13 in the Example 2 is changed from 85 μm to 125 μm.

In FIG. 6, in the V-groove 64b of the optical element 64, the end face of the GRIN lens 13 is pressed against and fixedly bonded to the closed end face of the V-groove 64b of the optical element 64 without an air layer between the surfaces while the optical fiber 11, GRIN lens 12 and GRIN lens 13 all having a diameter of 125 μm are connected into one integral piece by a process of melting.

Since the diameter of the GRIN lens 12 and GRIN lens 13 is changed from 85 μm to 125 μm, the light emitted from the GRIN lens 13 is slightly deviated toward the slider 15, and hence the position of convergence is shifted. The bonding position of the optical element 64 and the slider 15 is slightly changed from those in Example 2. Otherwise, the same conditions are used as those of the Example 2.

### Example 4

The same conditions as those of the Example 2 are used, except that the dimensions of the optical element 64 are changed to the values shown below:

In FIG. 6, the optical element 64 is fixedly bonded onto the slider 15. The optical element 64 has a length (traveling direction) of 0.9 mm, a thickness (direction of levitation) of 0.5 mm (0.34 mm on the lower step), a width (depth) of 0.8 mm, and the angle of deflection surface 64a of 45°. The V-groove 64b has a vertex angle of 80°, and is almost parallel with the lower surface of the optical element 64. The V-groove 64b has a thickness of 0.16 mm on the open end and 0.32 mm (length 0.35 mm, width (depth) 1 mm) on the closed end, the latter value being greater by the thickness of the step. This optical element 64 was molded by an injection molding die provided with a space (cavity) having the reverse form of the optical element 64 of FIG. 11 and a gate for filling with resin.

The differences in dimensions between the slider 15 and optical element 64 are 0.05 mm in length and 0.1 mm in width. The surface of the optical element 64 for fixing the slider 15 thereon was not affected by the burr that may be produced at the time of molding. Satisfactory bonding and fixing was achieved.

### Example 5

In FIG. 2, reference numeral 3 indicates an optical head, 11 an optical fiber, 12 and GRIN lens (GRIN lens A), 13 a GRIN lens (GRIN lens B), and 14 an optical element formed by integration of the 10-degree tilted V-groove 14b and deflection surface 14a. The reference numeral 15 indicates a slider, and 16 indicates an optical waveguide. FIG. 3 is a perspective view of the optical element 14.

In FIG. 2, the optical element 14 with V-groove 14b is bonded and fixed onto the slider 15. The optical element 14 has a length (traveling direction) of 0.85 mm, a thickness (direction of levitation) of 0.2 mm, a width (depth) of 0.7 mm, and the angle of deflection surface 14a of 46°. The V-groove 14b has a vertex angle of 88°, and has an depression angle of 2° declining to the deflection surface 14a. The bottom of the V-groove 14b has a thickness of 0.1 mm on the open end and 0.12 mm on the closed end, wherein the sectional area is made greater on the side wherein the V-groove is closed than on the side wherein it is open. This optical element 14 was molded by an injection molding die of FIG. 13 provided with a space (cavity) having the reverse form of the optical element 14 of FIG. 8 and a gate through which the resin is filled. The resin used is the ZEONEX® 480R (made by Nippon Zeon Co., Ltd., with a refractive index of 1.525) which is a thermoplastic resin.

In the V-groove 14b of the optical element 14, the end face of the GRIN lens 13 is pressed against and fixedly bonded to the closed end face of the V-groove 14b of the optical element 14 without an air layer between the surfaces while the optical fiber 11, GRIN lens 12 and GRIN lens 13 are connected into one integral piece by a process of melting.

The light flux coming out of the optical fiber 11 having a diameter of 85 μm is formed into a parallel light flux by the GRIN lens 12 having a length of 0.595 mm. The parallel light is converted into convergent light through the GRIN lens 13 with a length of 0.085 mm and is launched into the optical element 14 wherein the deflection surface 14a has an angle of 46°.

Thus, the incident angle with respect to the deflection surface 14a is 46°. The light flux deflected to approximately 92° on the deflection surface 14a is converged almost perpendicularly to the incident end face of the optical waveguide 16 to form a satisfactory optical spot, whereby optical coupling is performed. When the angle for deflecting the light flux by the deflection surface is set to 92°, the reflection on the deflection surface 14a of the optical element made of the ZEONEX® 480R having a smaller refractive index can be made closer to the full reflection. Further, when the V-groove 14b is tilted 2°, light enters in the direction perpendicular to the incident surface of the optical waveguide 16, with the result that light efficiency is enhanced. The mode field diameter of the optical fiber 11 is about 10 μm, and that of the optical waveguide 16 is also about 10 μm. The light emitted from the optical fiber 11 can be formed into the optical spot capable of meeting the mode field diameter of the optical waveguide 16 by the combination of the GRIN lens 12 and the GRIN lens 13. The magnification of this optical system can be 1:1.

The numerical values for the GRIN lenses 12 (GRIN lens A), (GRIN lens B) and the optical element 14 are the same as those of Table 2.

What is claimed is:

1. An optical element which is to be mounted on a slider moving on a recording medium, comprising:
a portion defining a groove, a first end of which is open and a second end of which is closed; and
a deflection surface which deflects a light guided from a light source through the second end of the groove,
wherein the optical element is formed of a fluid material transparent to the light, and a thickness of the material constituting a bottom part of the groove is greater at the second end than at the first end.

2. The optical element of claim 1, wherein the light from the light source is guided by a linear light guide into the optical element.

3. The optical element of claim 1, wherein the optical element is molded by injection molding using a metal mold which has a reverse form of the optical element.

4. The optical element of claim 3, wherein the optical element is formed by the metal mold having a gate through which the fluid material is injected, and the gate is provided on a surface of the metal mold other than any of the deflection surface, a surface on which an aperture of the groove exists, an opposite surface to the surface with the aperture and a surface on which the groove is open.

5. The optical element of claim 1, wherein the depth of the groove is smaller at the second end than at the first end.

6. The optical element of claim 1, wherein the thickness of the optical element is greater than or equal to 0.1 mm and less than or equal to 1 mm, and the following conditions are satisfied:
b<L≦k×b;
c<W≦k×c,
wherein
k=2: coefficient;
b: a length of the slider mounting the optical element thereon in a direction where the slider moves;
c: a width of the slider mounting the optical element thereon in a direction perpendicular to the direction where the slider moves;
L: a length of the optical element in the same direction as b;
W: a width of the optical element in the same direction as c.

7. The optical element of claim 2, a light-gathering element for gathering the light guided by the linear light guide is secured in the groove.

8. The optical element of claim 7, wherein the light-gathering element is secured on the bottom of the groove.

9. The optical element of claim 7, wherein the light-gathering element includes a graded index lens attached to the linear light guide.

10. An optical head, comprising:
an optical element, including:
a portion defining a groove, a first end of which is open and a second end of which is closed; and
a deflection surface which deflects a light guided from a light source through the second end of the groove, and
a slider which mounts the optical element thereon and moves above a recording medium,
wherein the optical element is formed of a fluid material transport to the light, and a thickness of the material constituting a bottom part of the groove is greater at the second end than at the first end.

11. The optical head of claim 10, wherein the slider is secured on a surface which has an aperture of the groove thereon, and a suspension for supporting the optical element is secured on an opposite surface to the surface which has the aperture.
